(19) United States
(12) Patent Application Publication
(10) Pub. No.: US 2025/0016856 A1
(43) Pub. Date: Jan. 9, 2025

(54) TDLS COEXISTENCE FOR NSTR OPERATION

(71) Applicant: Samsung Electronics Co., Ltd., Suwon-si (KR)

(72) Inventors: Rubayet Shafin, Allen, TX (US); Boon Loong Ng, Plano, TX (US); Yue Qi, Plano, TX (US); Peshal Nayak, Plano, TX (US); Vishnu Vardhan Ratnam, Plano, TX (US); Elliot Jen, Taipei City (TW)

(21) Appl. No.: 18/751,009

(22) Filed: Jun. 21, 2024

Related U.S. Application Data
(60) Provisional application No. 63/525,100, filed on Jul. 5, 2023.
(60) Provisional application No. 63/525,246, filed on Jul. 6, 2023.

(51) Int. Cl. H04W 76/14; H04W 76/15

(52) U.S. Cl. CPC H04W 76/14; H04W 76/15

(57) ABSTRACT

Methods and apparatuses for handling TDLS coexistence for EMLSR operation, EMLMR operation, and NSTR operation. A method for wireless communication performed by a non-access point (AP) multi-link device (MLD) that comprises stations (STAs), the method comprising: forming links with corresponding APs of an AP MLD; determining that a coexistence operation will be caused for the non-AP MLD; generating a notification frame to transmit to the AP MLD, the notification frame indicating a start time and an end time, the notification frame notifying the AP MLD to avoid transmission to the non-AP MLD between the start time and the end time so as to avoid causing the coexistence operation for the non-AP MLD; and transmitting the notification frame to the AP MLD.

### CROSS-REFERENCE TO RELATED APPLICATION AND CLAIM OF PRIORITY

This application claims priority under 35 U.S.C. § 119 (e) to U.S. Provisional Patent Application No. 63/525,100 filed on Jul. 5, 2023, and U.S. Provisional Patent Application No. 63/525,246 filed on Jul. 6, 2023, each of which is hereby incorporated by reference in its entirety.

### TECHNICAL FIELD

This disclosure relates generally to transmission efficiency in wireless communications systems that include multi-link devices. Embodiments of this disclosure relate to methods and apparatuses for handling tunneled direct link setup (TDLS) coexistence for enhanced multi-link single radio (EMLSR) operation, enhanced multi-link multi radio (EMLMR) operation, and non-simultaneous transmit/receive (NSTR) operation.

### BACKGROUND

Wireless local area network (WLAN) technology allows devices to access the internet in the 2.4 GHz, 5 GHz, 6 GHZ, or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

Multi-link operation (MLO) is a feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-access point (AP) multi-link device (MLD) to discover, authenticate, associate, and set up multiple links with an AP MLD. Channel access and frame exchange is possible on each link between the AP MLD and non-AP MLD.

### SUMMARY

Embodiments of the present disclosure provide methods and apparatuses for handling TDLS coexistence for EMLSR operation, EMLMR operation, and NSTR operation.

In one embodiment, a non-AP MLD is provided, comprising: stations (STAs), each comprising a transceiver configured to form a link with a corresponding AP of an AP MLD. The non-AP MLD further comprises a processor operably coupled to the STAs, the processor configured to: determine that a coexistence operation will be caused for the non-AP MLD; and generate a notification frame to transmit to the AP MLD, the notification frame indicating a start time and an end time, the notification frame notifying the AP MLD to avoid transmission to the non-AP MLD between the start time and the end time so as to avoid causing the coexistence operation for the non-AP MLD. The transceiver is configured to transmit the notification frame to the AP MLD.

In another embodiment, a method for wireless communication performed by a non-AP MLD that comprises STAs is provided, the method comprising: forming links with corresponding APs of an AP MLD; determining that a coexistence operation will be caused for the non-AP MLD; generating a notification frame to transmit to the AP MLD, the notification frame indicating a start time and an end time, the notification frame notifying the AP MLD to avoid transmission to the non-AP MLD between the start time and the end time so as to avoid causing the coexistence operation for the non-AP MLD; and transmitting the notification frame to the AP MLD.

In yet another embodiment, an AP MLD is provided, comprising: APs, each comprising a transceiver configured to form a link with a corresponding STA of a non-AP MLD. The AP MLD further comprises a processor operably coupled to the STAs, the processor configured to: receive a notification frame from the non-AP MLD based on a determination that a coexistence operation will be caused for the non-AP MLD, the notification frame indicating a start time and an end time, the notification frame notifying the AP MLD to avoid transmission to the non-AP MLD between the start time and the end time so as to avoid causing the coexistence operation for the non-AP MLD; and generate an acknowledgement frame indicating reception of the notification frame. The transceiver is configured to transmit the acknowledgement frame to the non-AP MLD.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. As used herein, such terms as “1st” and “2nd,” or “first” and “second” may be used to simply distinguish a corresponding component from another and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2A illustrates an example AP according to embodiments of the present disclosure;

FIG. 2B illustrates an example STA according to embodiments of the present disclosure;

FIG. 3 illustrates an example of a discovery process for discovering a single link TDLS according to embodiments of this disclosure;

FIG. 4 illustrates another example of a discovery process for discovering a TDLS according to embodiments of this disclosure;

FIG. 5 illustrates an example of the use of enhanced multi-link (EML) operating mode notification frame to transition into EMLSR mode according to embodiments of this disclosure;

FIG. 6 illustrates an example of a procedure for EMLMR mode of operation according to embodiments of this disclosure;

FIG. 7 illustrates an example where the non-AP MLD cannot process a TDLS discovery response frame because it has already moved the radio to another link due to EMLSR operation according to embodiments of the present disclosure;

FIG. 8 illustrates an example where the MLD_S cannot process a TDLS discover response frame because it has already moved the radio to another link due to EMLSR operation according to embodiments of the present disclosure;

FIG. 9 illustrates an example where the non-AP MLD cannot process a TDLS discovery response frame because it has already moved the radio to another link due to EMLMR operation according to embodiments of the present disclosure;

FIG. 10 illustrates an example where the MLD_S cannot process a TDLS discover response frame because it has already moved the radio to another link due to EMLMR operation according to embodiments of the present disclosure;

FIG. 11 illustrates an example of a problem with NSTR MLD in peer-to-peer communications according to embodiments of the present disclosure;

FIG. 12 illustrates an example ML TDLS transmission control field format according to embodiments of the present disclosure; and

FIG. 13 illustrates a flowchart of a method for wireless communication performed by a non-AP device according to embodiments of the present disclosure.

### DETAILED DESCRIPTION

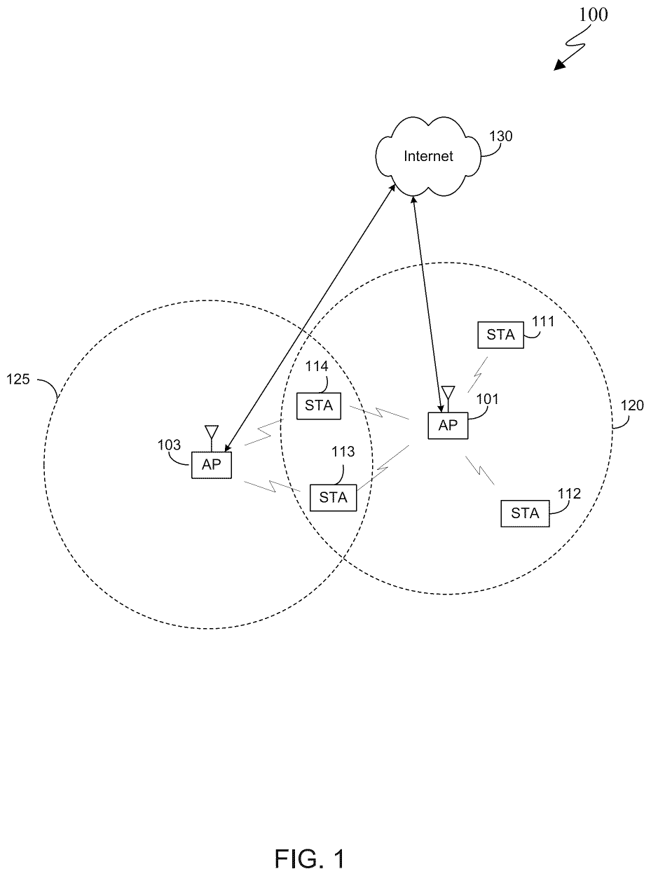

FIGS. 1 through 13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: IEEE P802.11be/D2.0 “Part 11: Wireless LAN Medium Access Control (MAC) and Physical Layer (PHY) Specifications—Amendment 8: Enhancements for extremely high throughput (EHT)”.

Embodiments of the present disclosure provide mechanisms for handling TDLS coexistence for EMLSR operation, EMLMR operation, or NSTR operation.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of STAs 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for facilitating handling of TDLS coexistence for EMLSR operation, EMLMR operation, or NSTR operation. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

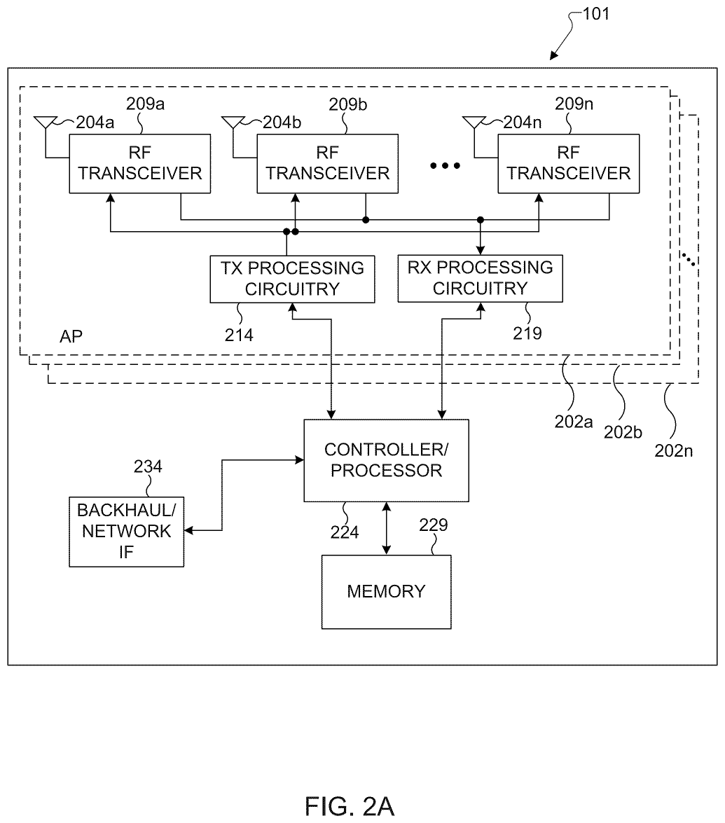

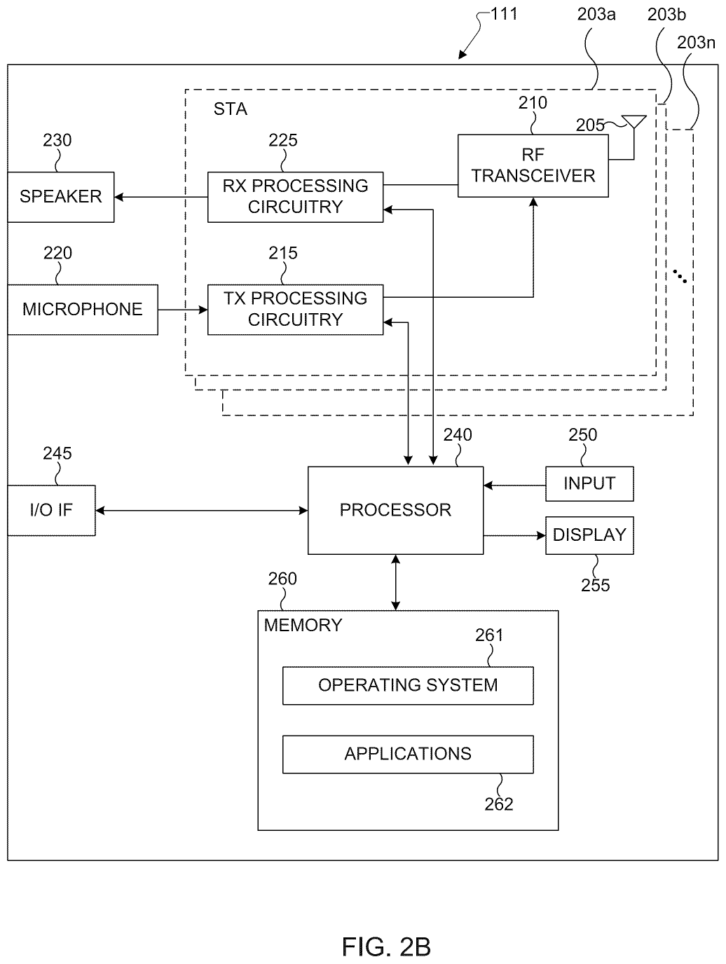

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed herein below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHZ, or 6 GHz, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHz, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP MLD 101 by the controller/processor 224 including facilitating handling of TDLS coexistence for EMLSR operation, EMLMR operation, or NSTR operation. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connection(s). For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for handling TDLS coexistence for EMLSR operation, EMLMR operation, or NSTR operation. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed herein below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a controller/processor 240, an input/output (I/O) interface (IF) 245, a touchscreen 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antenna(s) 205, an incoming RF signal transmitted by an AP of the network 100. In some embodiments, each affiliated STA 203a-203n operates at a different bandwidth, e.g., 2.4 GHz, 5 GHz, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHZ, or 6 GHz, the outgoing RF signals transmitted by each affiliated STA may be at a different frequency of RF.

The controller/processor 240 can include one or more processors and execute the basic OS program 261 stored in the memory 260 in order to control the overall operation of the non-AP MLD 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to support facilitating handling of TDLS coexistence for EMLSR operation, EMLMR operation, or NSTR operation. In some embodiments, the controller/processor 240 includes at least one microprocessor or microcontroller.

The controller/processor 240 is also capable of executing other processes and programs resident in the memory 260, such as operations for supporting facilitating handling of TDLS coexistence for EMLSR operation, EMLMR operation, or NSTR operation. The controller/processor 240 can move data into or out of the memory 260 as required by an executing process. In some embodiments, the controller/processor 240 is configured to execute a plurality of applications 262, such as applications for supporting facilitating handling of TDLS coexistence for EMLSR operation, EMLMR operation, or NSTR operation. The controller/processor 240 can operate the plurality of applications 262 based on the OS program 261 or in response to a signal received from an AP. The main controller/processor 240 is also coupled to the I/O interface 245, which provides non-AP MLD 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the non-AP MLD 111 can use the touchscreen 250 to enter data into the non-AP MLD 111. The display 255 may be a liquid crystal display, light emitting diode display, or other display capable of rendering text and/or at least limited graphics, such as from web sites. The memory 260 is coupled to the controller/processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antenna(s) 205 for MIMO communication with an AP 101. In another example, the non-AP MLD 111 may not include voice communication or the controller/processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

Various embodiments of the present disclosure recognize that in the single TDLS link discovery/setup process, when the MLD in the EMLSR mode (or a single radio non-AP MLD) is the TDLS initiator and a TDLS responding device is a legacy device, the TDLS discovery response can be sent over a link but the EMLSR device may not be operating on that link when the response frame is sent by the TDLS responder (the EMLSR device at that time may have the radio on another link). The response frame is not sent through the AP MLD.

Various embodiments of the present disclosure recognize that in the single TDLS link discovery/setup process, when the non-AP MLD in the EMLMR mode is the TDLS initiator and a TDLS responding device is a legacy device, the TDLS discovery response can be sent over a link that is included in the EMLMR links and the EMLMR device is involved in EMLMR frame exchange on another link. The EMLMR device may not have any radio left on the link on which the response frame is sent by the TDLS responder.

Various embodiments of the present disclosure recognize that while a non-AP MLD is communicating with its associated AP MLD and is operating under the EMLSR/EMLMR mode, how the non-AP MLD can start transmitting over a TDLS direct link where the link is one of the EMLSR/EMLMR links, is not clear.

Various embodiments of the present disclosure recognize that whenever there is a peer-to-peer link (e.g., TDLS link) between any pair of STAs affiliated with a pair of non-AP MLDs over one link, and if any of the non-AP MLDs is non-simultaneous transmit/receive (NSTR) capable over any of the links, the other NSTR link(s) become essentially ineffective.

Accordingly, various embodiments of the present disclosure provide a framework and mechanisms to handle the EMLSR/EMLMR coexistence issue with TDLS. Further, various embodiments of the present disclosure provide mechanisms to initiate transmission over a TDLS direct link by a STA affiliated with a non-AP MLD where the STA is operating on a link that is an EMLSR/EMLMR Links and the non-AP MLD is operating in the EMLSR/EMLMR mode. Further still, various embodiments of the present disclosure provide mechanisms for handling NSTR issues when one or more non-AP STAs, affiliated with a non-AP MLD and forming NSTR link pair(s), establish TDLS direct link with one or more non-AP STAs affiliated with another non-AP MLD.

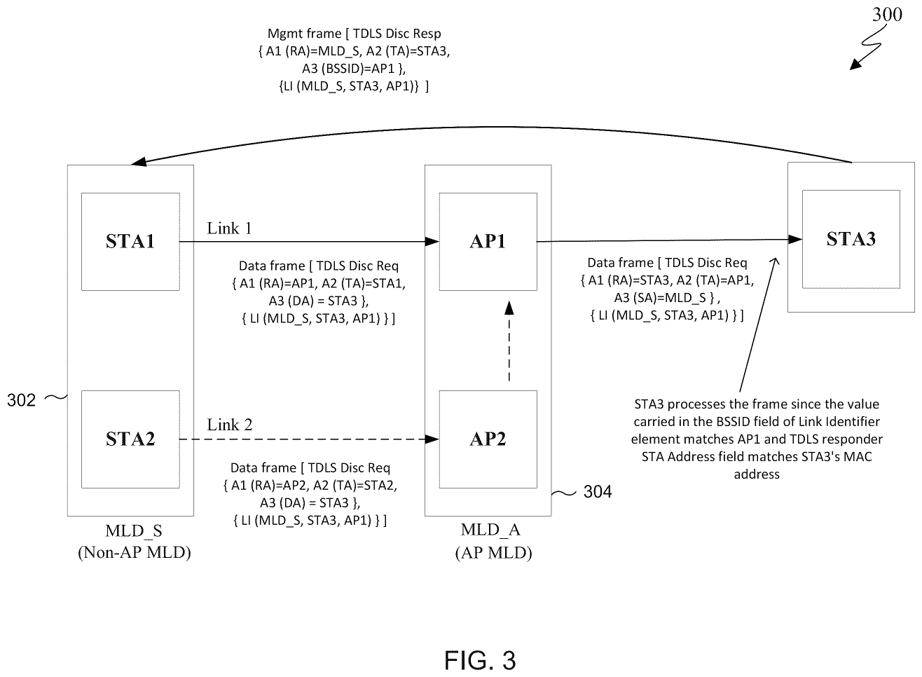

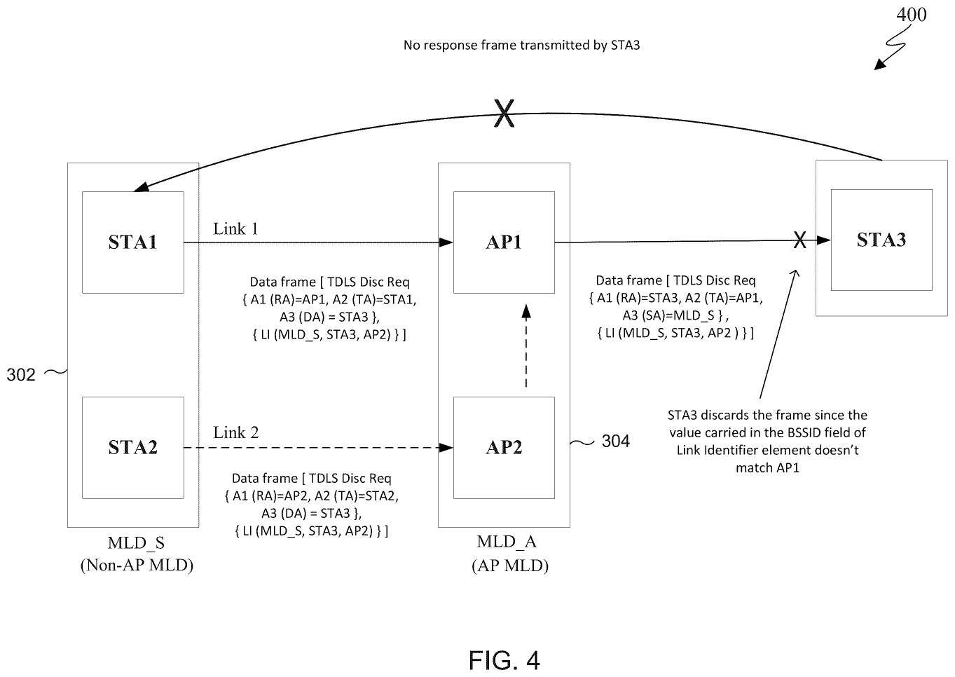

The procedure for discovery and setup of single link TDLS direct link between two non-AP MLDs is defined in the 802.11be specification. The discovery process for discovering a single TDLS peer STA is illustrated in FIG. 3 and FIG. 4.

FIG. 3 illustrates an example of a discovery process 300 for discovering a single link tunneled direct link setup (TDLS) according to embodiments of this disclosure. The embodiment of the example discovery process 300 shown in FIG. 3 is for illustration only. Other embodiments of the example discovery process 300 could be used without departing from the scope of this disclosure.

FIG. 4 illustrates another example of a discovery process 400 for discovering a TDLS according to embodiments of this disclosure. The embodiment of the example discovery process 400 shown in FIG. 4 is for illustration only. Other embodiments of the example discovery process 400 could be used without departing from the scope of this disclosure.

As illustrated in FIGS. 3 and 4, the TDLS discovery is initiated by a non-AP MLD (MLD_S) 302. The MLD_S 302 has performed multi-link setup with an AP MLD (MLD_A) 304. The MLD_S 302 has two affiliated STAs, STA1 and STA2. STA3 is not capable of performing multi-link operation and is not affiliated with a non-AP MLD. The MLD_A 304 has two affiliated APs, AP1 and AP2, where AP1 operates on link 1 and AP2 operates on link 2. STA1 and STA3 operate on link 1 and are associated with AP1. STA2 operates on link 2 and is associated with AP2. In the example, the MLD_S 302 initiates TDLS discovery by transmitting two TDLS Discovery Request frames (which are Data frames) as it does not know which link STA3 is operating on and whether STA3 is an MLD, or a STA not affiliated with an MLD. The first TDLS Discovery Request frame has the BSSID field in the Link Identifier element set to the BSSID of AP1 and the second TDLS Discovery Request frame has this field set to the BSSID of AP2. Both the frames have their A3 (DA) set to the STA3 MAC address and the To DS subfield of the Frame Control field set to 1. The TDLS Discovery Request frame can be transmitted over either link 1 (through STA as represented by solid line) or link 2 (through STA2 as represented by dotted line). When the TDLS Discovery Request frame is received at the AP MLD 304 (i.e., through AP1 or AP2), it routes the frame to STA3, through AP1 by setting the From DS subfield of the Frame Control field to 1 and A3 (SA) to the non-AP MLD Address (i.e., MLD_S). STA3 discards the TDLS Discovery Request frame that had the BSSID field of Link Identifier element set to BSSID of AP2 as it does not recognize the BSSID. STA3 recognizes the BSSID set to AP1 and responds with a TDLS Discovery Response frame, which is a Management frame, with the RA set to the MLD_S and both To DS and From DS subfields set to 0. STA3 ignores the TDLS Multi-Link element as it does not recognize this element. The TDLS STA affiliated with the MLD_S 302 receives the TDLS Discovery Response frame, which is sent on the TDLS direct link. The TDLS initiator STA Address field and the TDLS responder STA Address field contained in the Link Identifier element (denoted as LI in the figure) are carried in the TDLS Discovery Request frame and in the TDLS Discovery Response frame and are set to MLD_S and STA3, respectively.

The non-AP MLDs in 802.11be can have different capabilities in terms of multi-link operation. The current specification defines two special kinds of multi-link operations, namely, Enhanced Multi-Link Single-Radio Operation (EMLSR) and Enhanced Multi-Link Multi-Radio Operation (EMLMR).

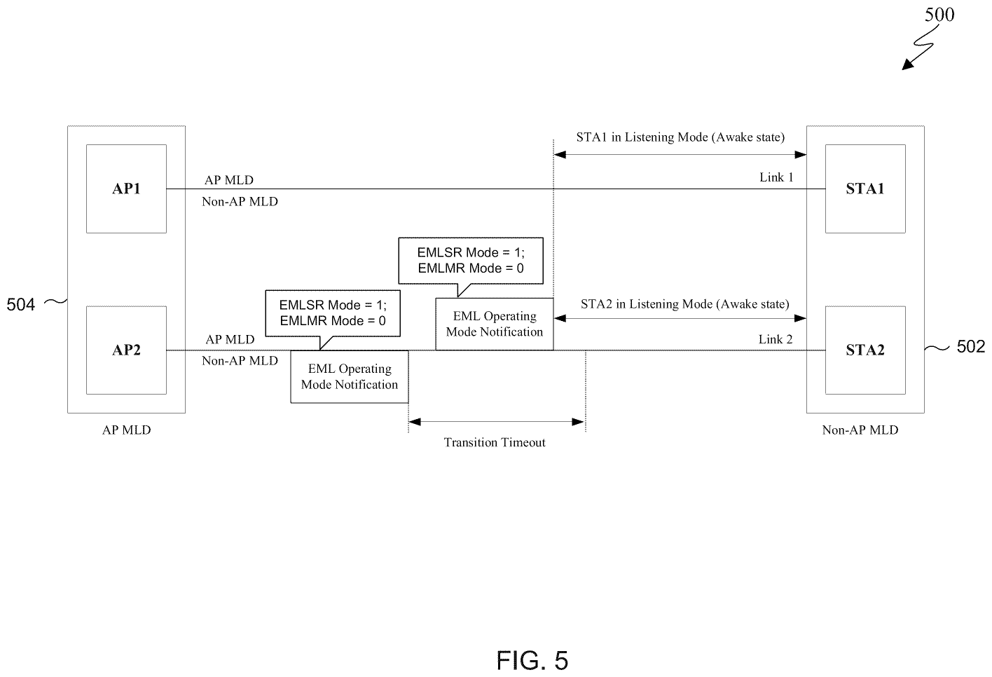

Many 802.11be non-AP MLDs may only have a single radio. EMLSR enables a multi-link operation with a single radio. With EMLSR operation, a non-AP MLD can achieve throughput enhancement with reduced latency-a performance close to concurrent dual radio non-AP MLDs. EMLSR operation and the behavior of STAs affiliated with non-AP MLD during EMLSR mode of operation are defined in 802.11be standards. According to current specifications, if a non-AP MLD intends to operate in EMLSR mode with its associated AP MLD, an STA affiliated with the non-AP MLD sends an EML Operating Mode Notification frame to its associated AP affiliated with the AP MLD, where the EMLSR Mode subfield in the EML Control field in the EML Operating Mode Notification frame is set to 1. Upon receiving the EML Operating Mode Notification frame from the non-AP MLD, the AP MLD can send, on any enabled link between the AP MLD and the non-AP MLD, another EML Operating Mode Notification frame, where the EMLSR Mode subfield in the EML Control field in the EML Operating Mode Notification frame is set to 1. The AP affiliated with the AP MLD is expected to send the EML Operating Mode Notification frame in response to the EML Operating Mode Notification frame sent by an STA affiliated with the non-AP MLD within the timeout interval indicated in the Transition Timeout subfield in EML Capabilities subfield in the Basic Variant Multi-Link element that is most recently exchanged between the AP MLD and the non-AP MLD. The non-AP MLD transitions to the EMLSR mode immediately after receiving the EML Operating Mode Notification frame with the EMLSR Mode subfield in the EML Control field set to 1 from an AP affiliated with the AP MLD or immediately after the timeout interval indicated in the Transition Timeout subfield in EML Capabilities field in the Basic Variant Multi-Link element elapses after the end of last PPDU contained in the EML Operating Mode Notification frame transmitted by the non-AP MLD, whichever occurs first. Upon transitioning into the EMLSR mode of operation, all STAs affiliated with the non-AP MLD transition to active mode (listening mode). This process for transitioning into the EMLSR mode using EML Operating Mode Notification frame exchanges is illustrated in FIG. 5.

FIG. 5 illustrates an example 500 of the use of an enhanced multi-link (EML) operating mode notification frame to transition into EMLSR mode according to embodiments of this disclosure. The embodiment of the example 500 of the use of an enhanced multi-link (EML) operating mode notification frame to transition into EMLSR mode shown in FIG. 5 is for illustration only. Other embodiments of the example 500 of the use of an enhanced multi-link (EML) operating mode notification frame to transition into EMLSR mode could be used without departing from the scope of this disclosure.

As illustrated in FIGS. 5, AP1 and AP2 are two APs affiliated with the AP MLD 504. Also, STA1 and STA2 are two non-AP STAs affiliated with the non-AP MLD 502. Two links are set up between the AP MLD 504 and the non-AP MLD 502-Link 1 between AP1 and STA1, and Link 2 between AP2 and STA2. Moreover, in this illustration, both Link 1 and Link 2 are enabled links. The non-AP MLD 504 intends to transition to the EMLSR mode, and accordingly, STA2 sends to AP2 over Link 2 an EML Operating Mode Notification frame with the EMLSR Mode subfield in the EML Control field set to 1. In response to the EML Operating Mode Notification frame transmitted by the non-AP MLD 504, AP2 sends to STA2 another EML Operating Mode Notification frame with the EMLSR Mode subfield in the EML Control field set to 1. After receiving the EML Operating Mode Notification frame from the AP MLD 502, the non-AP MLD 504 transitions into the EMLSR mode, and both STA1 and STA2 transition into listening mode.

Enhanced Multi-Link Multi-Radio (EMLMR) operation is another mode of operation newly defined in the IEEE 802.11be specification. With the EMLMR mode of operation, it is possible for a multi-link device with multiple radios to move transmit (TX)/receive (RX) chains from one link (for example, the first link) to another link (for example, the second link) of the same MLD, essentially increasing the spatial stream capability of the second link.

According to the current 802.11be specification, the procedure for a non-AP MLD's transitioning into EMLMR mode is quite similar to the procedure for transitioning into the EMLSR mode. According to the current 802.11be specification, if a non-AP MLD intends to operate in the EMLMR mode with its associated AP MLD, an STA affiliated with the non-AP MLD sends an EML Operating Mode Notification frame to its associated AP affiliated with the AP MLD, where the EMLMR Mode subfield in the EML Control field in the EML Operating Mode Notification frame is set to 1 (and the EMLSR Mode in the same frame is set to 0). Upon receiving the EML Operating Mode Notification frame from the non-AP MLD, the AP MLD can send, on any enabled link between the AP MLD and the non-AP MLD, another EML Operating Mode Notification frame, where the EMLMR Mode subfield in the EML Control field in the EML Operating Mode Notification frame is set to 1. The AP affiliated with the AP MLD is expected to send the EML Operating Mode Notification frame in response to the EML Operating Mode Notification frame sent by an STA affiliated with the non-AP MLD within the timeout interval indicated in the Transition Timeout subfield in the EML Capabilities subfield in the Basic Variant Multi-Link element that is most recently exchanged between the AP MLD and the non-AP MLD. The non-AP MLD transitions to the EMLMR mode immediately after receiving the EML Operating Mode Notification frame with the EMLMR Mode subfield in the EML Control field set to 1 from an AP affiliated with the AP MLD or immediately after the timeout interval indicated in the Transition Timeout subfield in the EML Capabilities field in the Basic Variant Multi-Link element elapses after the end of last PPDU contained in the EML Operating Mode Notification frame transmitted by the non-AP MLD, whichever occurs first. The following are some of the steps for operating in the EMLMR mode:
After the non-AP MLD transitions into EMLMR mode, it is the AP MLD that sends the Initial Frame to the non-AP MLD. The subsequent EMLMR frame exchanges occur on the link on which the AP MLD sends the Initial Frame.
According to the current 802.11be specification, the initial frame can be any frame that is sent by the AP MLD to the non-AP MLD as the first frame after the non-AP MLD transitions into EMLMR mode.
According to current 802.11be specification, the AP MLD, for EMLMR frame exchanges, shall select one of the links that are included as the EMLMR links.
After the AP MLD sends the initial frame on a link, the non-AP MLD is able to operate on that link with maximum spatial stream as indicated by the values in the EMLMR Rx NSS and EMLMR Tx NSS subfields in the EML Capabilities subfield of the Common Info field of the Basic Multi-Link element.
Immediately after the EMLMR frame exchange sequence is complete, the STAs affiliated with the AP MLD go back to operate with the per-link spatial stream capability.

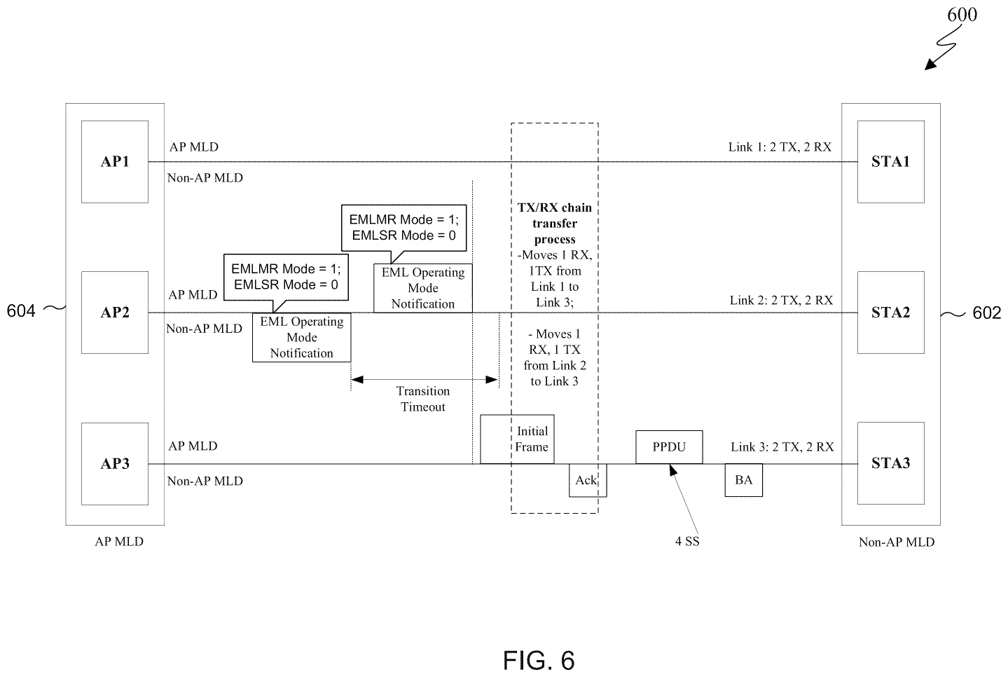

FIG. 6 illustrates an example of a procedure 600 for EMLMR mode of operation according to embodiments of this disclosure. The embodiment of the example procedure 600 for EMLMR mode of operation shown in FIG. 6 is for illustration only. Other embodiments of the example procedure 600 for EMLMR mode of operation could be used without departing from the scope of this disclosure.

As illustrated in FIG. 6, the AP MLD 604 has three affiliated APs: AP1 operating on 2.4 GHz band, AP2 operating on 5 GHz band, and AP3 operating on 6 GHz band. The non-AP MLD 602 has three affiliated STAs: STA1 operating on 2.4 GHz band, STA2 operating on 5 GHz band, and STA3 operating on 6 GHz band. Three links are established between the AP MLD 604 and the non-AP MLD 602: Link 1 between AP1 and STA1, Link 2 between AP2 and STA2, and Link 3 between AP3 and STA3. The non-AP MLD 602 is a multi-radio non-AP MLD, where STA1, STA2, and STA3 each has two transmit chains and two receive chain. Both the AP MLD 604 and the non-AP MLD 602 support the EMLMR mode of operation. The non-AP AP MLD 602 lists all three links, Link 1, Link 2, and Link 3, as the EMLMR links. In the Basic Multi-Link element exchanged between the AP MLD 604 and the non-AP MLD 602, the EML Capabilities Present subfield is set to 1, and both the EMLMR Rx NSS and EMLME Tx NSS subfields in the EML Capabilities subfield is set to the value of 4. At one point of time of operation, the non-AP MLD 602 intends to enter into EMLMR mode and sends an EML Operating Mode Notification frame to the AP MLD 604 on Link 2. In that EML Operating Mode Notification frame, the EMLMR Mode subfield in the EML Control field is set to 1 and the EMLSR Mode subfield in the EML Control field is set to 0. Upon receiving the EML Operating Mode Notification frame on Link 2, AP2 affiliated with the AP MLD 604 sends, in response, another EML Operating Mode Notification frame to the non-AP MLD 602 on Link 2 and sets the EMLMR Mode subfield in the EML Control field to 1 and the EMLSR Mode subfield in the EML Control field to 0 in the EML Operating Mode Notification frame. Upon receiving the EML Operating Mode Notification frame from the AP MLD 604, which is transmitted before the timeout timer indicated in the Transition Timeout subfield in the EML Capabilities subfield in the Basic Multi-Link element expires, the non-AP MLD 602 transitions into EMLMR mode. After the non-AP MLD 602 transitions into EMLMR mode, the AP MLD 604 sends the initial frame on Link 3 to initiate the frame exchanges for EMLMR operation. Upon receiving the initial frame on Link 3, the non-AP MLD 602—
Transfers 1 transmit chain and 1 receive chain from Link 1 to Link 3
Transfers 1 transmit chain and 1 receive chain from Link 2 to Link 3.

After the transmit and receive chain transfer process is complete, Link 3 now has 4 transmit chains and 4 receive chains. Therefore, STA3 affiliated with the non-AP MLD 602 can now perform transmit and receive operation using 4 spatial streams on Link 3, in accordance with the value set in the EMLMR Rx NSS and EMLMR Tx NSS subfields in the EML Capabilities subfield of the Basic Multi-link element. STA 3 affiliated with the non-AP MLD 602 then sends an Ack frame in response to the initial control frame sent by the AP MLD 604. Accordingly, the AP MLD 604 performs subsequent PPDU transmission to the non-AP MLD 602 on Link 3 using 4 spatial streams. After the EMLMR frame exchange sequence, STAs affiliated with the non-AP MLD 602 are able to perform based on per-link spatial stream capability.

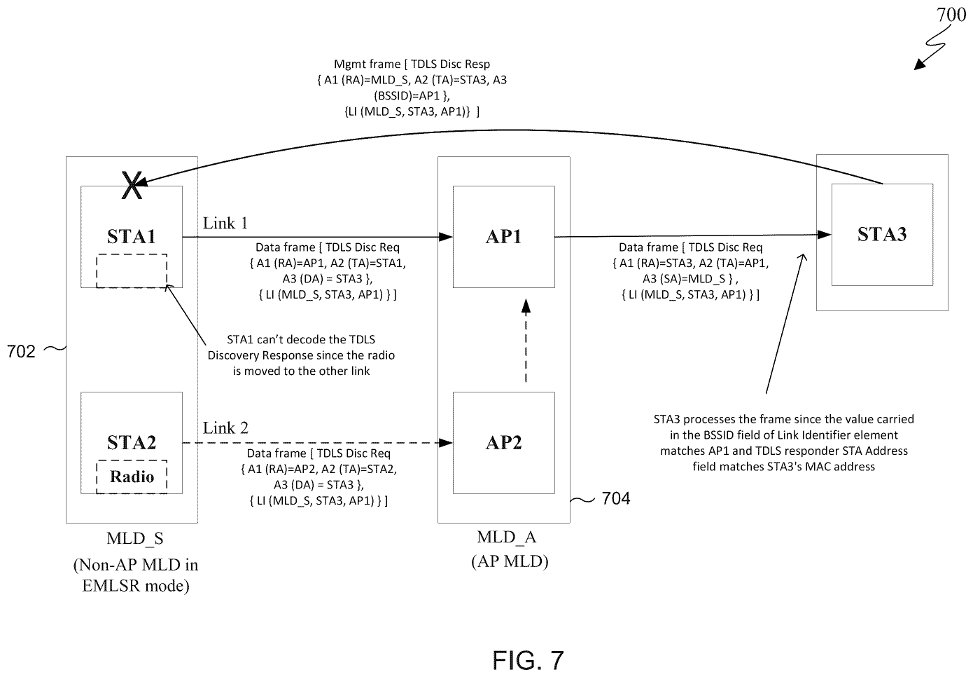

FIG. 7 illustrates an example 700 where the non-AP MLD cannot process a TDLS discovery response frame because it has already moved the radio to another link due to EMLSR operation according to embodiments of the present disclosure. The embodiment of the example 700 where the non-AP MLD cannot process a TDLS discovery response frame because it has already moved the radio to another link due to EMLSR operation shown in FIG. 7 is for illustration only. Other embodiments of the example 700 where the non-AP MLD cannot process a TDLS discovery response frame because it has already moved the radio to another link due to EMLSR operation could be used without departing from the scope of this disclosure.

As illustrated in FIG. 7, when the MLD in the EMLSR mode (or a single radio non-AP MLD) is the TDLS initiator and a TDLS responding device is a legacy device, the TDLS discovery response can be sent over a link, but the EMLSR device may not be operating on that link when the response frame is sent by the TDLS responder (the EMLSR device at that time may have the radio on another link). Note that the response frame is not sent through the AP MLD 704. The non-AP MLD 702 does not know on which link STA3 would be sending the response frame. STA3 can send the response on Link-1 but due to EMLSR operation the radio might have already moved to another link (Link 2 in the figure).

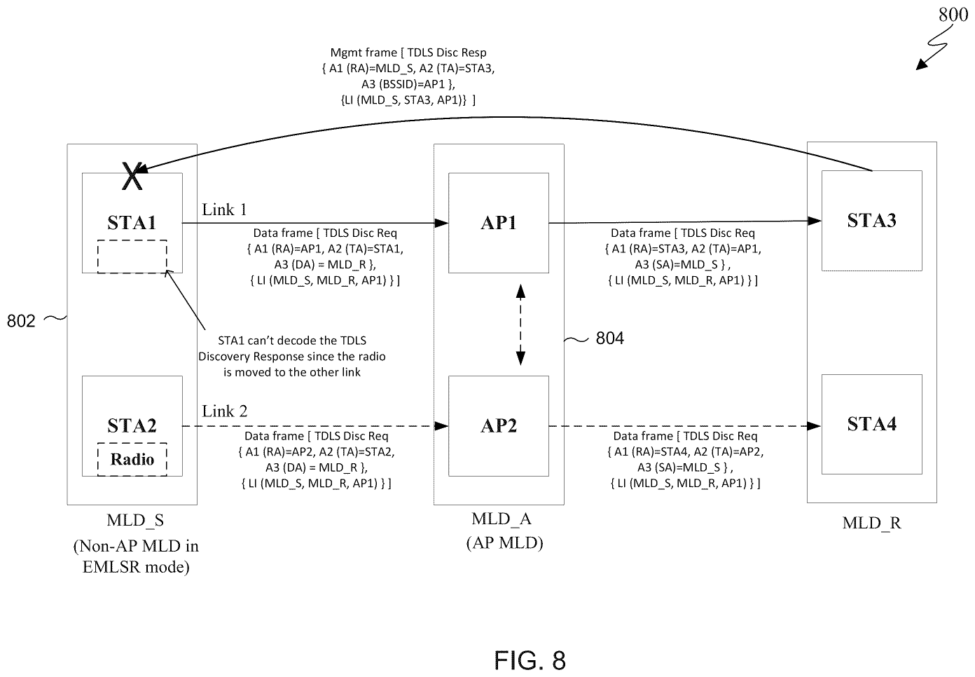

Accordingly, the non-AP MLD 702 cannot process the discovery response frame. The same situation can also happen even when the TDLS responder operates on both links as illustrated in FIG. 8.

FIG. 8 illustrates an example 800 where the MLD_S cannot process a TDLS discovery response frame because it has already moved the radio to another link due to EMLSR operation according to embodiments of the present disclosure. The embodiment of the example 800 where the MLD_S cannot process a TDLS discovery response frame because it has already moved the radio to another link due to EMLSR operation shown in FIG. 8 is for illustration only. Other embodiments of the example 800 where the MLD_S cannot process a TDLS discovery response frame because it has already moved the radio to another link due to EMLSR operation could be used without departing from the scope of this disclosure.

As illustrated in FIG. 8, when the MLD_S 802 in the EMLSR mode is the TDLS initiator and a TDLS responding device is a legacy device, the TDLS discovery response can be sent over a link, but the EMLSR device may not be operating on that link when the response frame is sent by the TDLS responder (the EMLSR device at that time may have the radio on another link). Note that the response frame is not sent through the AP MLD 804. The non-AP MLD 802 does not know on which link STA3 or STA 4 would be sending the response frame. STA3 can send the response on Link 1—but due to EMLSR operation the radio might have already moved to another link (Link 2 in the figure). STA4 can send the response on Link 2—but due to EMLSR operation the radio might have already moved to another link (Link 1 in the figure). Accordingly, the non-AP MLD 802 cannot process the discovery response frame because it has already moved the radio to another link due to EMLSR operation.

If the non-AP MLD is the TDLS initiator and if all the TDLS Discovery Request frames are sent on one link (for example, the first link) for discovering TDLS peer STAs on different links, it is possible that the TDLS peer STA that is a TDLS responder may send the TDLS Discovery Response frame on a second link. However, due to the EMLSR operation, it is possible that the non-AP MLD does not have the radio left on the second link. Hence, the non-AP MLD may not be able to receive the TDLS Discovery Response frame and hence cannot discover the responder TDLS peer STA.

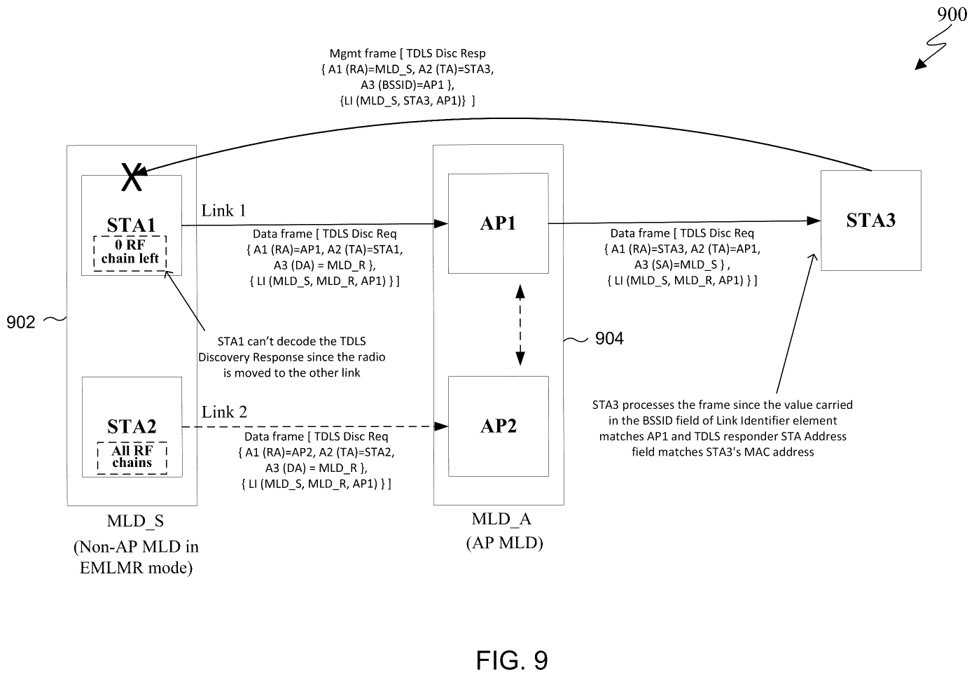

FIG. 9 illustrates an example 900 where the non-AP MLD cannot process a TDLS discovery response frame because it has already moved the radio to another link due to EMLMR operation according to embodiments of the present disclosure. The embodiment of the example 900 where the non-AP MLD cannot process a TDLS discovery response frame because it has already moved the radio to another link due to EMLMR operation shown in FIG. 9 is for illustration only. Other embodiments of the example 900 where the non-AP MLD cannot process a TDLS discovery response frame because it has already moved the radio to another link due to EMLMR operation could be used without departing from the scope of this disclosure.

As illustrated in FIG. 9, the non-AP MLD 902 does not know on which link STA3 would be sending the response frame. STA3 can send the response on Link-1 but due to EMLMR operation, the radio and all the RF chains might have already moved to another link (Link 2 in the figure).

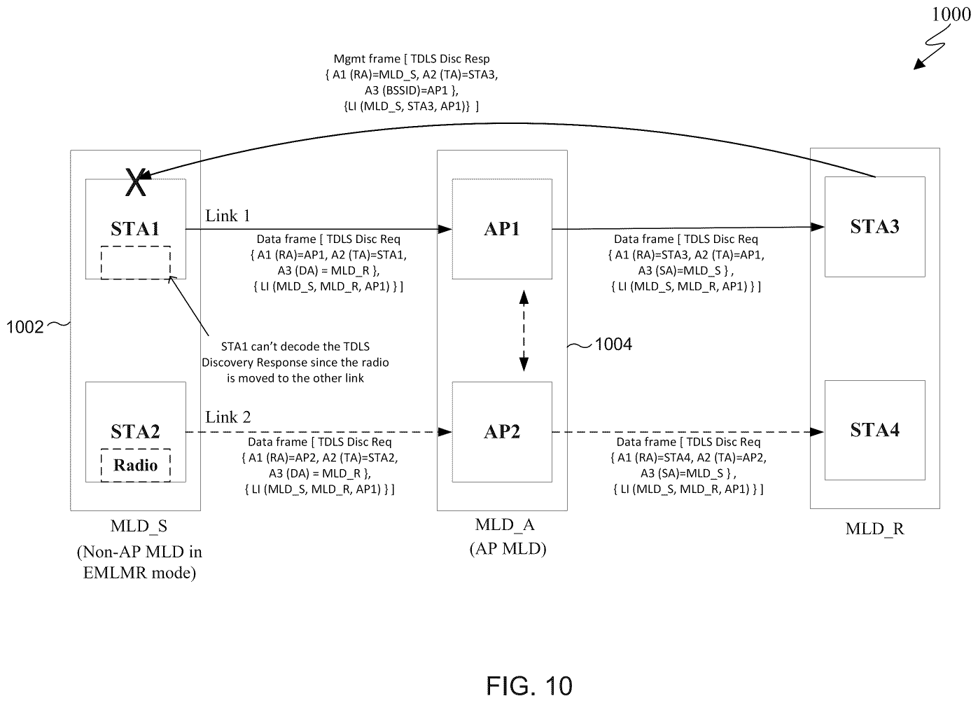

Accordingly, the non-AP MLD cannot process the discovery response frame. The same situation can also happen even when the TDLS responder operates on both links. This is illustrated in FIG. 10.

FIG. 10 illustrates an example 1000 where the MLD_S cannot process a TDLS discover response frame because it has already moved the radio to another link due to EMLMR operation according to embodiments of the present disclosure. The embodiment of the example 1000 where the MLD_S cannot process a TDLS discover response frame because it has already moved the radio to another link due to EMLMR operation shown in FIG. 10 is for illustration only. Other embodiments of the example 1000 where the MLD_S cannot process a TDLS discover response frame because it has already moved the radio to another link due to EMLMR operation could be used without departing from the scope of this disclosure.

As illustrated in FIG. 10, the non-AP MLD 1002 does not know on which link STA3 or STA4 would be sending the response frame. STA3 can send the response on Link 1—but due to EMLSR operation the radio might have already moved to another link (Link 2 in the figure). STA4 can send the response on Link 2—but due to EMLSR operation the radio might have already moved to another link (Link 1 in the figure). Accordingly, the non-AP MLD 1002 cannot process the discovery response frame because it has already moved the radio to another link due to EMLSR operation.

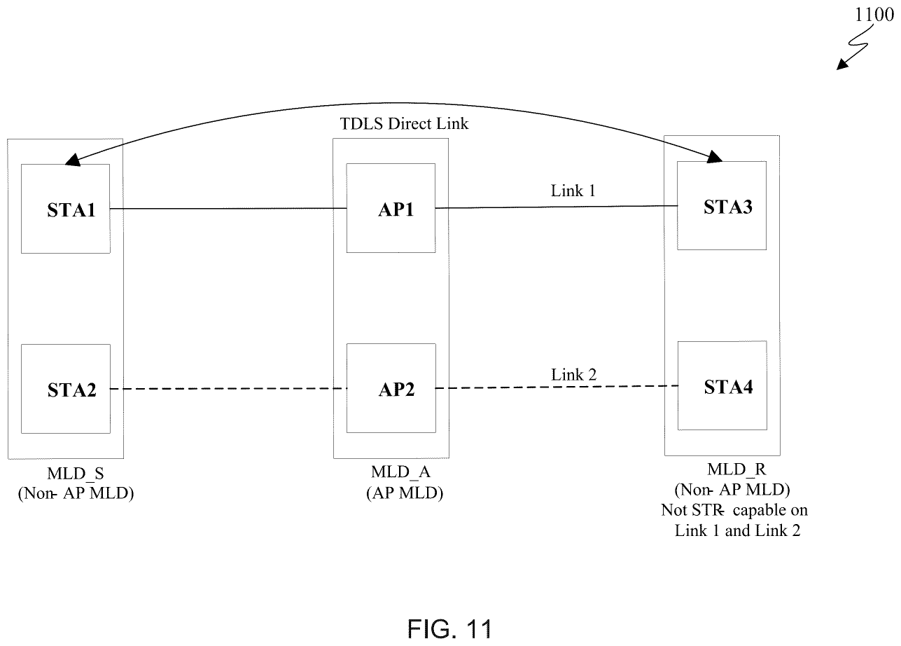

FIG. 11 illustrates an example 1100 of a problem with NSTR MLD in peer-to-peer communications according to embodiments of the present disclosure. The embodiment of the example 1100 of a problem with NSTR MLD in peer-to-peer communications shown in FIG. 11 is for illustration only. Other embodiments of the example 1100 of a problem with NSTR MLD in peer-to-peer communications could be used without departing from the scope of this disclosure.

As illustrated in FIG. 11, MLDs and MLDR are two non-AP MLDs and MLD_{A} is an AP MLD. STA1 and STA2 are two STAs affiliated with MLDs; STA3 and STA4 are two STAs affiliated with MLDR; AP1 and AP2 are two APs affiliated with MLD_{A}. Two links have been set up between MLDs and MLD_{A} - - - one between STA1 and AP1, and the other between STA2 and AP2. Moreover, two links have been set up between MLDR and MLD_{A} - - - one between STA3 and

AP1, and the other between STA4 and AP2. STA3 and STA4, operating on Link 1 and Link 2, respectively, form an NSTR link pair. Now, a TDLS direct link has been established between STA1 and STA3. When STA3 is communicating to STA1 over the TDLS direct link, AP MLD, MLD_{A}, usually is not aware of the communication over the TDLS link (AP1 may not always monitor the TDLS direct link. In order for the TDLS to be used, the AP does not need to be direct-link aware, nor does it have to support the same set of capabilities that are used on the direct link. MLD_{A} is aware of MLDRS NSTR capability; so, without the TDLS link, as long as STA3 is not transmitting to AP1 over Link 1, AP2 may perform downlink transmission to STA4 over Link 2. However, over the TDLS direct link, if STA3 is transmitting to STA1, then STA4 would not be able to receive the packets from AP2 over Link2.

In another example scenario, referring again to FIG. 11, if STA3 has some pending latency sensitive traffic for its TDLS peer STA, STA1, then MLDR needs a mechanism to notify the AP MLD about the impending TDLS transmission by STA3 so that AP2 can terminate any ongoing downlink transmission to STA4 before the transmission starts over the TDLS direct link.

In general, a mechanism is needed to notify the AP MLD about an impending transmission over the TDLS direct link so that the AP MLD can manage its downlink transmission to avoid any NSTR interference to either the non-AP MLD that hosts the transmitting TDLS peer STA and the non-AP MLD that hosts the receiving TDLS peer STA at the other end of the TDLS direct link in the case that the receiving TDLS peer STA is also affiliated with a non-AP MLD with NSTR constraints with the TDLS direct link.

According to one embodiment, a format of the Protected EHT Action field including the ML TDLS Transmission Notification frame and ML TDLS Transmission Acknowledgement frame is shown in Table I.

TABLE I
Protected EHT Action field values

| | | Time |
|---|---|---|
| Value | Meaning | priority |
| 0 | TID-To-Link Mapping Request | No |
| 1 | TID-To-Link Mapping Response | No |
| 2 | TID-To-Link Mapping Teardown | No |
| 3 | EPCS Priority Access Enable Request | No |
| 4 | EPCS Priority Access Enable Response | No |
| 5 | EPCS Priority Access Teardown | No |
| 6 | EML Operating Mode Notification | No |
| 7 | Link Recommendation | No |
| 8 | Multi-Link Operation Update Request | No |
| 9 | Multi-Link Operation Update Response | No |
| 10 | Link Reconfiguration Notify | No |
| 11 | Link Reconfiguration Request | No |
| 12 | Link Reconfiguration Response | No |
| 13 | ML TDLS Transmission Notification | No |
| 14 | ML TDLS Transmission Acknowledgement | No |
| 15-255 | Reserved | |

According to one embodiment, a format of the Protected EHT Action field including the ML TDLS Transmission Notification frame is shown in Table II.

TABLE II
Protected EHT Action field values

| | | Time |
|---|---|---|
| Value | Meaning | priority |
| 0 | TID-To-Link Mapping Request | No |
| 1 | TID-To-Link Mapping Response | No |
| 2 | TID-To-Link Mapping Teardown | No |
| 3 | EPCS Priority Access Enable Request | No |
| 4 | EPCS Priority Access Enable Response | No |
| 5 | EPCS Priority Access Teardown | No |
| 6 | EML Operating Mode Notification | No |
| 7 | Link Recommendation | No |
| 8 | Multi-Link Operation Update Request | No |
| 9 | Multi-Link Operation Update Response | No |
| 10 | Link Reconfiguration Notify | No |
| 11 | Link Reconfiguration Request | No |
| 12 | Link Reconfiguration Response | No |
| 13 | ML TDLS Transmission Notification | No |
| 14-255 | Reserved | |

### ML TDLS Transmission Notification Frame Format

According to one embodiment, the ML TDLS Transmission Notification frame is shown in Table III, and is sent by a STA affiliated with a non-AP MLD to notify the associated AP MLD about a transmission over a TDLS direct link by a STA affiliated with the non-AP MLD. The Action field of the ML TDLS Transmission Notification frame contains the information shown in Table III (ML TDLS Transmission Notification frame Action field format).

TABLE III
ML TDLS Transmission Notification frame Action field format

| Order | Information |
|---|---|
| 1 | Category |
| 2 | Protected EHT Action |
| 3 | Dialog Token |
| 4 | ML TDLS Control |
| 5 | Link Identifier |

The Category field is defined in 9.4.1.11 (Action field) of the baseline spec.

The Protected EHT Action field is defined in 9.6.35.1 (Protected EHT Action field).

The Dialog Token field is defined in 9.4.1.12 (Dialog Token field) and is set to a nonzero value chosen by the non-AP MLD sending the ML TDLS Transmission Request frame to identify the notification/acknowledgement transaction.

The ML TDLS Control field is defined in 9.4.1.xx3 (ML TDLS Control field).

The Link Identifier field contains a Link Identifier element as specified in 9.4.2.60 (Link Identifier element) in order to identify the TDLS direct link that corresponds to the transmission for which the ML TDLS Transmission Notification frame is used to notify the AP MLD.

### ML TDLS Control Field

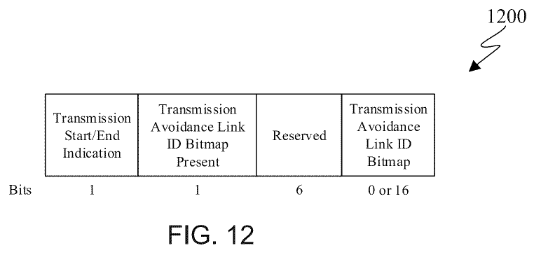

FIG. 12 illustrates an example ML TDLS transmission control field format 1200 according to embodiments of the present disclosure. The embodiment of the example ML TDLS transmission control field format 1200 shown in FIG. 12 is for illustration only. Other embodiments of the example ML TDLS transmission control field format 1200 could be used without departing from the scope of this disclosure.

As illustrated in FIG. 12, the Transmission Start/End Indication subfield indicates whether the ML TDLS Transmission Notification frame indicates the start or the end of a TDLS frame transmission over a TDLS direct link identified by the Link Identifier element in the ML TDLS Transmission Notification frame. If the subfield is set to 1, then the ML TDLS Transmission Notification frame indicates the start of an impending TDLS transmission by a TDLS peer STA affiliated with a non-AP MLD. If the subfield is set to 0, then the TDLS Transmission Notification frame indicates the end of an ongoing TDLS frame transmission by the STA affiliated with the non-AP MLD.

The Transmission Avoidance Link ID Bitmap Present subfield indicates the presence of the Transmission Avoidance Link ID Bitmap subfield in the ML TDLS Control field. The Transmission Avoidance Link ID Bitmap Present subfield is set to 1 if the Transmission Avoidance Link ID Bitmap subfield is present in the ML TDLS Control field; otherwise, it is set to 0.

The Transmission Avoidance Link ID Bitmap subfield, if present, indicates the links for which the non-AP MLD that transmits the ML TDLS Transmission frame requests the associated AP MLD to suspend any downlink transmission to the non-AP MLD. If the non-AP MLD requests the AP MLD to suspend any downlink transmission on link i between the AP MLD and the non-AP MLD, then the i-th bit in the Transmission Avoidance Link ID Bitmap subfield is set to 1; otherwise, it is set to 0.

### ML TDLS Transmission Acknowledgement Frame Format

According to one embodiment, the ML TDLS Transmission Acknowledgement frame is sent by an AP affiliated with an AP MLD in response to an ML TDLS Transmission Notification frame received from a STA affiliated with a non-AP MLD that is associated with the AP MLD. The Action field of the ML TDLS Transmission Acknowledgement frame contains the information shown in Table IV (ML TDLS Transmission Notification frame Action field format).

TABLE IV
ML TDLS Transmission Acknowledgement
frame Action field format

| Order | Information |
|---|---|
| 1 | Category |
| 2 | Protected EHT Action |
| 3 | Dialog Token |
| 4 | Status Code |

The Category field is defined in 9.4.1.11 (Action field).

The Protected EHT Action field is defined in 9.6.35.1 (Protected EHT Action field).

The Dialog Token field is defined in 9.4.1.12 (Dialog Token field) and is set to a nonzero value chosen by the non-AP MLD sending the ML TDLS Transmission Request frame to identify the notification/acknowledgement transaction.

The Status Code field is defined in 9.4.1.9 (Status Code field).

The Status Codes field including the status for DENIED_TDLS_TRANSMISSION_REQUEST is shown in Table V.

TABLE V
Status codes

| Status code | Name | Meaning |
|---|---|---|
| . . . | . . . | . . . |
| 18 | REFUSED_BASIC_RATES_MIS- | Association denied due to requesting |
| | MATCH | STA not supporting all of the data |
| | | rates in the BSSBasicRateSet |
| | | parameter, the Basic HT-MCS Set |
| | | field of the HT Operation parameter, |
| | | the Basic VHT-MCS And NSS Set |
| | | field in the VHT Operation |
| | | parameter, [symbol] the Basic HE-MCS And |
| | | NSS Set field in the HE Operation |
| | | parameter, or the Basic EHT-MCS |
| | | And NSS Set field in the EHT |
| | | Operation parameter. |
| . . . | . . . | . . . |
| 39 | REJECTED_WITH_SUGGESTED_{—} | The allocation or TS (#15014) or SCS |
| | CHANGES | stream has not been created because |
| | | the request cannot be honored; |
| | | however, a suggested TSPEC/DMG |
| | | TSPEC or QoS Characteristics |
| | | element is provided so that the |
| | | initiating STA can attempt to set |
| | | another allocation or TS or SCS |
| | | stream with the suggested changes to |
| | | the TSPEC/DMG TSPEC or QoS |
| | | Characteristics element. |
| . . . | . . . | . . . |
| 130 | DENIED_STA_AFFILIATED_{—} | Association denied because the |
| | WITH_MLD_WITH_EXISTING_{—} | requesting STA is affiliated with a |
| | MLD_ASSOCIATION | non-AP MLD that is associated with |
| | | the AP MLD. |
| 131 | EPCS_DENIED_UNAUTHORIZED | EPCS priority access denied because |
| | | the non-AP MLD is not authorized to |
| | | use the service. |
| 132 | EPCS_DENIED(#16367) | EPCS priority access denied due to a |
| | | reason outside the scope of this |
| | | standard. |
| 133 | DENIED_TID_TO_LINK_MAPPING | Request denied because the requested |
| | | TID-to-link map- ping is |
| | | unacceptable. |
| 134 | PREFERRED_TID_TO_LINK_MAP- | Preferred TID-to-link mapping |
| | PING_SUGGESTED | suggested. |
| 135 | DENIED_EHT_NOT_SUPPORTED | Association denied because the |
| | | requesting STA does not support |
| | | EHT features. |
| . . . | | |
| 139 | DENIED_LINK_ON_WHICH_THE | Link not accepted because the link on |
| | (RE)ASSOCIATION_REQUEST_{—} | which the (Re)Association Request |
| | FRAME_IS_TRANSMIT- | frame is transmitted is not accepted. |
| | TED_NOT_ACCEPTED(#16789) | |
| 140 | EPCS_DENIED_VERIFICATION_- | EPCS priority access is temporarily |
| | FAILURE | denied because the receiving AP |
| | | MLD is unable to verify that the |
| | | non-AP MLD is authorized for an |
| | | unspecified reason. |
| 141 | DENIED_OPERATION_PARAME- | Operation parameter update denied |
| | TER_UPDATE | because the requested operation |
| | | parameters or capabilities are not |
| | | acceptable. |
| 142 | DENIED_TDLS_TRANSMISSION_{—} | The downlink transmission |
| | REQUEST | suspension request made by the ML |
| | | TDLS Transmission Notification |
| | | frame is declined. |

### TDLS Procedure in Multi-Link Operation TDLS Channel Access

According to one embodiment, if a TDLS peer STA affiliated with a non-AP MLD forms one or more NSTR link pair(s) with other STA(s) affiliated with the same non-AP MLD, then before the TDLS peer STA starts transmitting the first frame within an obtained TXOP over the TDLS direct link, the non-AP MLD, through any enabled link, shall send an ML TDLS Transmission Notification frame with Transmission Start/End Indication subfield set to 1 to the AP MLD notifying about the impending transmission over the TDLS direct link identified by the Link Identifier element of the ML TDLS Transmission Notification frame. Upon reception of the ML TDLS Transmission Notification frame, the AP MLD should send an ML TDLS Transmission Acknowledgement frame to the non-AP MLD over any enabled link and should end any downlink transmission to any STA affiliated with the non-AP MLD and operating on a link indicated by the Transmission Avoidance Link ID Bitmap subfield of the ML TDLS Control field. The AP MLD should not initiate transmission of any PPDU to the non-AP MLD on any of the links identified by the Transmission Avoidance Link ID Bitmap subfield until the AP MLD receives an ML TDLS Transmission Notification frame from the non-AP MLD with the Transmission Start/End Indication subfield set to 0. Upon reception of the ML TDLS Transmission Acknowledgement frame by the non-AP MLD with the Status Code SUCCESS, the TDLS peer STA affiliated with the non-AP MLD may start transmission over the TDLS direct link. Once the TDLS peer STA ends its transmission over the TDLS direct link, the non-AP MLD, through any enabled link, shall send an ML TDLS Transmission Notification frame with Transmission Start/End Indication subfield set to 0 to the AP MLD notifying about the end of the ongoing transmission over the TDLS direct link by the TDLS peer STA operating on the TDLS direct link identified by the Link Identifier element included in the ML TDLS Transmission Notification frame.

According to one embodiment, if a non-AP MLD is operating in EMLSR/EMLMR mode, and a STA affiliated with the non-AP MLD and operating on one of the EMLSR/EMLMR Links intends to initiate a TDLS discovery/setup process (see 35.3.21.1 (General) and 35.3.21.2 (TDLS direct link over a single link)) or intends to transmit a frame over a TDLS direct link, then before the STA initiates the TDLS discovery/setup process or before the STA starts transmission over the TDLS direct link, the non-AP MLD, through any enabled link between the AP MLD and the non-AP MLD, shall send an ML TDLS Transmission Notification frame with Transmission Start/End Indication subfield set to 1 to the AP MLD notifying about the impending initiation of the TDLS discovery/setup process or impending transmission over the TDLS direct link identified by the Link Identifier element of the ML TDLS Transmission Notification frame. In the ML TDLS Transmission Notification frame, the Transmission Avoidance Link ID Bitmap Present subfield shall be set to 0. Upon reception of the ML TDLS Transmission Notification frame, the AP MLD should send an ML TDLS Transmission Acknowledgement frame to the non-AP MLD over any enabled link and should end any downlink transmission to any STA affiliated with the non-AP MLD and operating on one of the EMLSR/EMLMR Links. The AP MLD should not initiate transmission of any PPDU to the non-AP MLD on any of the EMLSR/EMLMR Links until the AP MLD receives an ML TDLS Transmission Notification frame from the non-AP MLD with the Transmission Start/End Indication subfield set to 0. Upon reception of the ML TDLS Transmission Acknowledgement frame by the non-AP MLD with the Status Code SUCCESS, the TDLS peer STA affiliated with the non-AP MLD may start transmission over the TDLS direct link. Once the TDLS peer STA completes setting up the TDLS direct link or ends its transmission over the TDLS direct link, the non-AP MLD, through any enabled link, shall send an ML TDLS Transmission Notification frame with Transmission Start/End Indication subfield set to 0 to the AP MLD notifying about the completion of the TDLS setup process or end of the ongoing transmission over the TDLS direct link by the TDLS peer STA operating on the TDLS direct link identified by the Link Identifier element included in the ML TDLS Transmission Notification frame.

According to one embodiment, if a STA is affiliated with a non-AP MLD where the non-AP MLD is operating on either EMLSR or EMLMR mode and the STA is operating on a first link that is either within the set of EMLSR Links or EMLMR Links, then if the STA has any operation on that first link such that any downlink transmission from the AP MLD, either to the first link or any other links of the non-AP MLD, would cause coexistence issue for that non-AP MLD, then the non-AP MLD may send the ML TDLS Transmission Notification frame to the AP MLD requesting to suspend its downlink transmission to the non-AP MLD so that no coexistence issue is created. The usage of the ML TDLS Transmission Notification frame and the TDLS Transmission Acknowledgement frame in this scenario can be the same as described in the previous embodiment.

According to one embodiment, if a STA is affiliated with a non-AP MLD where the non-AP MLD is operating on either EMLSR or EMLMR mode and the STA is operating on a first link that is either within the set of EMLSR Links or EMLMR Links, then if the STA has any operation on that first link such that any downlink transmission from the AP MLD, either to the first link or any other links of the non-AP MLD, would cause coexistence issue for that non-AP MLD, then the non-AP MLD can send an EML Operating Mode Notification frame to the AP MLD indicating the coexistence issue. In such case, the EML Operating Mode Notification frame may have a subfield that can indicate that the non-AP MLD has coexistence issue. This new subfield in the EML Operating Mode Notification frame can be termed as Coexistence Activities Present subfield. If the Coexistence Activities Present subfield is set to 1, it indicates that the non-AP MLD has coexistence activities going on; if the Coexistence Activities Present subfield is set to 0, it indicates that the non-AP MLD does not have any coexistence activities going on. Transmitting the EML Operating Mode Notification frame to the AP MLD by the non-AP MLD where the Coexistence Activities Present subfield is set to 1 would alert the AP MLD about the coexistence operation that the non-AP MLD is having. While the non-AP MLD is having a coexistence operation, if, upon transmitting an EML Operating Mode Notification frame to the non-AP MLD, the AP MLD does not receive a response from the non-AP MLD with another EML Operating Mode Notification frame, then the AP MLD may have the understanding that the non-AP MLD may be involved in coexistence operation (e.g., P2P/TDLS) and might to penalize the non-AP MLD by, for example, lowering the data rate and MCS.

According to one embodiment, if a TDLS peer STA affiliated with a non-AP MLD forms one or more NSTR link pair(s) with other STA(s) affiliated with the same non-AP MLD, then before the TDLS peer STA starts transmitting the first frame within an obtained TXOP over the TDLS direct link, the non-AP MLD, through any enabled link, shall send an ML TDLS Transmission Notification frame with Transmission Start/End Indication subfield set to 1 to the AP MLD notifying about the impending transmission over the TDLS direct link by the TDLS peer STA operating on the link identified by the Link Identifier element of the ML TDLS Transmission Notification frame. Upon reception of the ML TDLS Transmission Notification frame, the AP MLD should send an ML TDLS Transmission Acknowledgement frame to the non-AP MLD over any enabled link and should end any downlink transmission to any STA affiliated with the non-AP MLD and operating on a link indicated by the Transmission Avoidance Link ID Bitmap subfield of the ML TDLS Transmission Control field. Upon reception of the ML TDLS Transmission Acknowledgement frame by the non-AP MLD with the Status Code SUCCESS, the TDLS peer STA affiliated with the non-AP MLD may start transmission over the TDLS direct link.

According to one embodiment, once the TDLS peer STA ends its transmission over the TDLS direct link, the non-AP MLD, through any enabled link, shall send an ML TDLS Transmission Notification frame with Transmission Start/End Indication subfield set to 0 to the AP MLD notifying about the end of the ongoing transmission over the TDLS direct link by the TDLS peer STA operating on the link identified by the Link Identifier element included in the ML TDLS Transmission Notification frame.

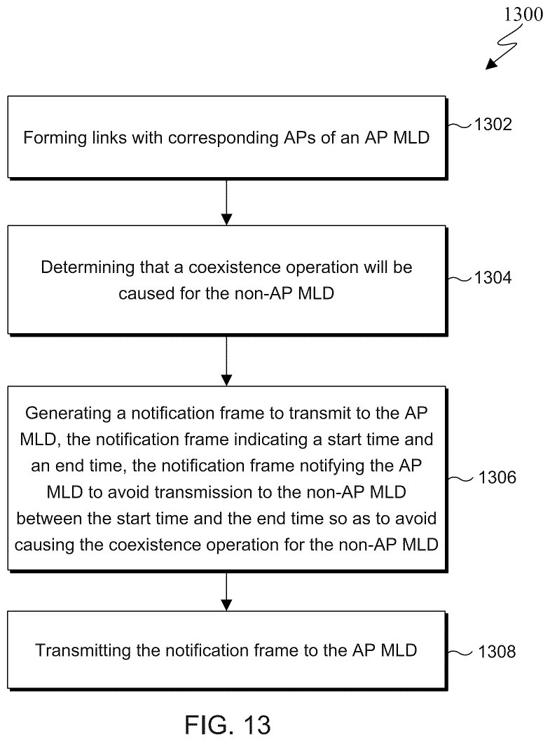

FIG. 13 illustrates a flowchart of a method 1300 for wireless communication performed by a non-AP MLD device according to embodiments of the present disclosure. The embodiment of the example method 1300 shown in FIG. 13 is for illustration only. Other embodiments of the example method 1300 could be used without departing from the scope of this disclosure.

As illustrated in FIG. 13, the method 1300 begins at step 1302, where the non-AP MLD forms links with corresponding APs of an AP MLD. At step 1304, the non-AP MLD determines that a coexistence operation will be caused for the non-AP MLD. At step 1306, the non-AP MLD generates a notification frame to transmit to the AP MLD, the notification frame indicating a start time and an end time, the notification frame notifying the AP MLD to avoid transmission to the non-AP MLD between the start time and the end time so as to avoid causing the coexistence operation for the non-AP MLD. At step 1308, the non-AP MLD transmits the notification frame to the AP MLD.

In one embodiment, the coexistence operation comprises a non-simultaneous transmit and receive (NSTR) operation; a first STA of the STAs comprises a tunneled direct link setup (TDLS) peer STA affiliated with the non-AP MLD; and when the TDLS peer STA affiliated with the non-AP MLD forms an NSTR link pair with a second STA affiliated with the non-AP MLD, the non-AP MLD is configured, before the TDLS peer STA starts transmitting a first frame over a TDLS direct link, to transmit the notification frame to the AP MLD.

In one embodiment, the coexistence operation comprises an enhanced multi-link single-radio (EMLSR) operation; at least one of the links comprises an EMLSR link configured to operate in an EMLSR mode of operation; and when a third STA of the STAs affiliated with the non-AP MLD intends to initiate a tunneled direct link setup (TDLS) process or intends to transmit a third frame over a TDLS direct link, the non-AP MLD is configured, before the third STA initiates the TDLS process or before the third STA starts transmission over a TDLS direct link, to transmit the notification frame to the AP MLD.

In one embodiment, the coexistence operation comprises an enhanced multi-link multi-radio (EMLMR) operation; at least one of the links comprises an EMLMR link configured to operate in an EMLMR mode of operation; and when a fourth STA of the STAs affiliated with the non-AP MLD intends to initiate a tunneled direct link setup (TDLS) process or intends to transmit a fourth frame over a TDLS direct link, the non-AP MLD is configured, before the fourth STA initiates the TDLS process or before the fourth STA starts transmission over a TDLS direct link, to transmit the notification frame to the AP MLD.

In one embodiment, the coexistence operation comprises an enhanced multi-link single-radio (EMLSR) operation; at least one of the links comprises an EMLSR link configured to operate in an EMLSR mode of operation; and when a fifth STA of the STAs affiliated with the non-AP MLD is operating on a link that comprises an EMLSR link, the non-AP MLD is configured to transmit the notification frame to the AP MLD to avoid causing the coexistence operation for the non-AP MLD.

In one embodiment, the coexistence operation comprises an enhanced multi-link multi-radio (EMLMR) operation; at least one of the links comprises an EMLMR link configured to operate in an EMLMR mode of operation; and when a sixth STA of the STAs affiliated with the non-AP MLD is operating on a link that comprises an EMLSR link, the non-AP MLD is configured to transmit the notification frame to the AP MLD to avoid causing the coexistence operation for the non-AP MLD.

In one embodiment, the coexistence operation comprises an enhanced multi-link single-radio (EMLSR) operation; at least one of the links comprises an EMLSR link configured to operate in an EMLSR mode of operation; when a seventh STA of the STAs affiliated with the non-AP MLD is operating on a link that comprises an EMLSR link, the non-AP MLD is configured to transmit the notification frame to the AP MLD to avoid causing the coexistence operation for the non-AP MLD; and the notification frame is an enhanced multi-link notification frame.

In one embodiment, the coexistence operation comprises an enhanced multi-link multi-radio (EMLMR) operation; at least one of the links comprises an EMLMR link configured to operate in an EMLMR mode of operation; when an eighth STA of the STAs affiliated with the non-AP MLD is operating on a link that comprises an EMLSR link, the non-AP MLD is configured to transmit the notification frame to the AP MLD to avoid causing the coexistence operation for the non-AP MLD; and the notification frame is an enhanced multi-link notification frame.

The above flowcharts illustrate example methods that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A non-access point (AP) multi-link device (MLD) comprising:
stations (STAs), each comprising a transceiver configured to form a link with a corresponding AP of an AP MLD; and
a processor operably coupled to the STAs, the processor configured to:
determine that a coexistence operation will be caused for the non-AP MLD; and
generate a notification frame to transmit to the AP MLD, the notification frame indicating a start time and an end time, the notification frame notifying the AP MLD to avoid transmission to the non-AP MLD between the start time and the end time so as to avoid causing the coexistence operation for the non-AP MLD,
wherein the transceiver is configured to transmit the notification frame to the AP MLD.

2. The non-AP MLD of claim 1, wherein:
the coexistence operation comprises a non-simultaneous transmit and receive (NSTR) operation;
a first STA of the STAs comprises a tunneled direct link setup (TDLS) peer STA affiliated with the non-AP MLD; and
when the TDLS peer STA affiliated with the non-AP MLD forms an NSTR link pair with a second STA affiliated with the non-AP MLD, the non-AP MLD is configured, before the TDLS peer STA starts transmitting a first frame over a TDLS direct link, to transmit the notification frame to the AP MLD.

3. The non-AP MLD of claim 1, wherein:
the coexistence operation comprises an enhanced multi-link single-radio (EMLSR) operation;
at least one of the links comprises an EMLSR link configured to operate in an EMLSR mode of operation; and
when a third STA of the STAs affiliated with the non-AP MLD intends to initiate a tunneled direct link setup (TDLS) process or intends to transmit a third frame over a TDLS direct link, the non-AP MLD is configured, before the third STA initiates the TDLS process or before the third STA starts transmission over a TDLS direct link, to transmit the notification frame to the AP MLD.

4. The non-AP MLD of claim 1, wherein:
the coexistence operation comprises an enhanced multi-link multi-radio (EMLMR) operation;
at least one of the links comprises an EMLMR link configured to operate in an EMLMR mode of operation; and
when a fourth STA of the STAs affiliated with the non-AP MLD intends to initiate a tunneled direct link setup (TDLS) process or intends to transmit a fourth frame over a TDLS direct link, the non-AP MLD is configured, before the fourth STA initiates the TDLS process or before the fourth STA starts transmission over a TDLS direct link, to transmit the notification frame to the AP MLD.

5. The non-AP MLD of claim 1, wherein:
the coexistence operation comprises an enhanced multi-link single-radio (EMLSR) operation;
at least one of the links comprises an EMLSR link configured to operate in an EMLSR mode of operation; and
when a fifth STA of the STAs affiliated with the non-AP MLD is operating on a link that comprises an EMLSR link, the non-AP MLD is configured to transmit the notification frame to the AP MLD to avoid causing the coexistence operation for the non-AP MLD.

6. The non-AP MLD of claim 1, wherein:
the coexistence operation comprises an enhanced multi-link multi-radio (EMLMR) operation;
at least one of the links comprises an EMLMR link configured to operate in an EMLMR mode of operation; and
when a sixth STA of the STAs affiliated with the non-AP MLD is operating on a link that comprises an EMLSR link, the non-AP MLD is configured to transmit the notification frame to the AP MLD to avoid causing the coexistence operation for the non-AP MLD.

7. The non-AP MLD of claim 1, wherein:
the coexistence operation comprises an enhanced multi-link single-radio (EMLSR) operation;
at least one of the links comprises an EMLSR link configured to operate in an EMLSR mode of operation;
when a seventh STA of the STAs affiliated with the non-AP MLD is operating on a link that comprises an EMLSR link, the non-AP MLD is configured to transmit the notification frame to the AP MLD to avoid causing the coexistence operation for the non-AP MLD; and
the notification frame is an enhanced multi-link notification frame.

8. The non-AP MLD of claim 1, wherein:
the coexistence operation comprises an enhanced multi-link multi-radio (EMLMR) operation;
at least one of the links comprises an EMLMR link configured to operate in an EMLMR mode of operation;
when an eighth STA of the STAs affiliated with the non-AP MLD is operating on a link that comprises an EMLSR link, the non-AP MLD is configured to transmit the notification frame to the AP MLD to avoid causing the coexistence operation for the non-AP MLD; and
the notification frame is an enhanced multi-link notification frame.

9. A method of wireless communication performed by a non-access point (AP) multi-link device (MLD) that comprises stations (STAs), the method comprising:
forming links with corresponding AP s of an AP MLD;
determining that a coexistence operation will be caused for the non-AP MLD;
generating a notification frame to transmit to the AP MLD, the notification frame indicating a start time and an end time, the notification frame notifying the AP MLD to avoid transmission to the non-AP MLD between the start time and the end time so as to avoid causing the coexistence operation for the non-AP MLD; and
transmitting the notification frame to the AP MLD.

10. The method of claim 9, wherein:
the coexistence operation comprises a non-simultaneous transmit and receive (NSTR) operation;
a first STA of the STAs comprises a tunneled direct link setup (TDLS) peer STA affiliated with the non-AP MLD; and
when the TDLS peer STA affiliated with the non-AP MLD forms an NSTR link pair with a second STA affiliated with the non-AP MLD, and before the TDLS peer STA starts transmitting a first frame over a TDLS direct link, the method further comprises transmitting the notification frame to the AP MLD.

11. The method of claim 9, wherein:
the coexistence operation comprises an enhanced multi-link single-radio (EMLSR) operation;
at least one of the links comprises an EMLSR link configured to operate in an EMLSR mode of operation; and
when a third STA of the STAs affiliated with the non-AP MLD intends to initiate a tunneled direct link setup (TDLS) process or intends to transmit a third frame over a TDLS direct link, and before the third STA initiates the TDLS process or before the third STA starts transmission over a TDLS direct link, the method further comprises transmitting the notification frame to the AP MLD.

12. The method of claim 9, wherein:
the coexistence operation comprises an enhanced multi-link multi-radio (EMLMR) operation;
at least one of the links comprises an EMLMR link configured to operate in an EMLMR mode of operation; and
when a fourth STA of the STAs affiliated with the non-AP MLD intends to initiate a tunneled direct link setup (TDLS) process or intends to transmit a fourth frame over a TDLS direct link, and before the fourth STA initiates the TDLS process or before the fourth STA starts transmission over a TDLS direct link, the method further comprises transmitting the notification frame to the AP MLD.

13. The method of claim 9, wherein:
the coexistence operation comprises an enhanced multi-link single-radio (EMLSR) operation;
at least one of the links comprises an EMLSR link configured to operate in an EMLSR mode of operation; and
when a fifth STA of the STAs affiliated with the non-AP MLD is operating on a link that comprises an EMLSR link, the method further comprises transmitting the notification frame to the AP MLD to avoid causing the coexistence operation for the non-AP MLD.

14. The method of claim 9, wherein:
the coexistence operation comprises an enhanced multi-link multi-radio (EMLMR) operation;
at least one of the links comprises an EMLMR link configured to operate in an EMLMR mode of operation; and
when a sixth STA of the STAs affiliated with the non-AP MLD is operating on a link that comprises an EMLSR link, the method further comprises transmitting the notification frame to the AP MLD to avoid causing the coexistence operation for the non-AP MLD.

15. The method of claim 9, wherein:
the coexistence operation comprises an enhanced multi-link single-radio (EMLSR) operation;
at least one of the links comprises an EMLSR link configured to operate in an EMLSR mode of operation;
when a seventh STA of the STAs affiliated with the non-AP MLD is operating on a link that comprises an EMLSR link, the method further comprises transmitting the notification frame to the AP MLD to avoid causing the coexistence operation for the non-AP MLD; and
the notification frame is an enhanced multi-link notification frame.

16. The non-AP MLD of claim 9, wherein:
the coexistence operation comprises an enhanced multi-link multi-radio (EMLMR) operation;
at least one of the links comprises an EMLMR link configured to operate in an EMLMR mode of operation;
when an eighth STA of the STAs affiliated with the non-AP MLD is operating on a link that comprises an EMLSR link, the method further comprises transmitting the notification frame to the AP MLD to avoid causing the coexistence operation for the non-AP MLD; and
the notification frame is an enhanced multi-link notification frame.

17. An access point (AP) multi-link device (MLD) comprising:
access points (APs), each comprising a transceiver configured to form a link with a corresponding station (STA) of a non-AP MLD; and
a processor operably coupled to the STAs, the processor configured to:
receive a notification frame from the non-AP MLD based on a determination that a coexistence operation will be caused for the non-AP MLD, the notification frame indicating a start time and an end time, the notification frame notifying the AP MLD to avoid transmission to the non-AP MLD between the start time and the end time so as to avoid causing the coexistence operation for the non-AP MLD; and
generate an acknowledgement frame indicating reception of the notification frame,
wherein the transceiver is configured to transmit the acknowledgement frame to the non-AP MLD.

18. The AP MLD of claim 17, wherein:
the coexistence operation comprises an enhanced multi-link single-radio (EMLSR) operation;
at least one of the links comprises an EMLSR link configured to operate in an EMLSR mode of operation; and
the AP MLD is configured to send the acknowledgement frame to the non-AP MLD over any enabled link and end downlink transmission to any STA affiliated with the non-AP MLD and operating on one of the EMLSR links.

19. The AP MLD of claim 17, wherein:
the coexistence operation comprises an enhanced multi-link multi-radio (EMLMR) operation;
at least one of the links comprises an EMLMR link configured to operate in an EMLMR mode of operation; and
the AP MLD is configured to send the acknowledgement frame to the non-AP MLD over any enabled link and end downlink transmission to any STA affiliated with the non-AP MLD and operating on one of the EMLMR links.

20. The AP MLD of claim 17, wherein:
the coexistence operation comprises a non-simultaneous transmit and receive (NSTR) operation; and
the AP MLD is configured to send the acknowledgement frame to the non-AP MLD over any enabled link and end downlink transmission to any STA affiliated with the non-AP MLD and operating on a link indicated by the notification frame.
